(19) United States
(12) Patent Application Publication
(10) Pub. No.: US 2025/0237862 A1
(43) Pub. Date: Jul. 24, 2025

(54) APPARATUSES, SYSTEMS, AND METHODS FOR METASURFACE DESIGN

(71) Applicant: Quantinuum LLC, Broomfield, CO (US)

(72) Inventors: Adam Jay Ollanik, Boulder, CO (US); David M. Gaudiosi, Loveland, CO (US); Bruce Gregory Tiemann, Longmont, CO (US)

(21) Appl. No.: 18/946,375

(22) Filed: Nov. 13, 2024

Related U.S. Application Data
(60) Provisional application No. 63/623,443, filed on Jan. 22, 2024.

(51) Int. Cl. G02B 27/00; B82Y 20/00

(52) U.S. Cl. CPC G02B 27/0012; B82Y 20/00; G02B 2207/101

(57) ABSTRACT

Example embodiments provide methods, systems, apparatuses, computer program products and/or the like for reducing diffractive orders arising from metasurface optics. In various embodiments, reducing diffractive orders is achieved by intentional apodization of emergent superstructures and/or intentional amplitude apodization of metasurface apertures. For example, various embodiments provide methods for designing and/or fabricating metasurfaces using a metastructure library that includes parameters defining a plurality of metastructures indexed by respective effective phase delays imparted to light that interacts with the corresponding metastructures. For at least one effective phase delay, the metastructure library comprises parameters that define at least two metastructures that differ in at least one of size or shape and that are indexed by the same effective phase delay.

### TECHNICAL FIELD

Various embodiments relate to apparatuses, systems, and methods relating to and/or including metasurfaces and design thereof with reduced diffractive orders. Various embodiments relate to apparatuses, systems, and methods relating to and/or including metasurfaces and design thereof with apodized superstructures. An example embodiment relates to confined object quantum computing (e.g., quantum charge-coupled device (QCCD)-based quantum computing) wherein meta material structures are disposed and/or formed on a surface of an atomic object confinement apparatus of a confined object quantum computer.

### BACKGROUND

Metasurfaces are optical components comprising a plurality or array of metastructures. Due to fabrication errors, design errors, finite apertures, and/or the like, metasurface optics are imperfect. Through applied effort, ingenuity, and innovation, many deficiencies of prior metasurface design techniques have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for reducing diffractive orders arising from metasurface optics. In various embodiments, reducing diffractive orders is achieved by intentional apodization of emergent superstructures and/or intentional amplitude apodization of metasurface apertures. For example, various embodiments provide methods, systems, apparatuses, computer program products, and/or the like for designing metasurfaces where formation of periodic structures within the metasurface is prevented. For example, various embodiments provide metasurfaces that include metastructures that are configured to provide a same phase delay (mod 2π) and that are different sizes and/or different shapes. The different sizes and/or different shapes of the metastructures that are configured to provide the same phase delay (mod 2π) are used to prevent the creation of periodic structures in the metasurface. For example, various embodiments provide metasurfaces that have non-uniform boundaries configured to apodize the respective metasurface apertures.

According to an aspect, a method for designing and/or generating a metasurface is provided. In an example embodiment, the method includes determining and/or obtaining a desired phase profile of a metasurface. The desired phase profile indicates a respective desired phase delay for each of a plurality of positions of the metasurface. The method further includes, for each position of the plurality of positions of the metasurface, selecting a respective metastructure from a metastructure library based on the respective desired phase delay. The metastructure library comprises a plurality of metastructures indexed by respective phase delays and, for at least one phase delay, the metastructure library comprises at least two metastructures that differ in at least one of size or shape and that are indexed by the at least one phase delay.

In an example embodiment, a boundary of the metasurface defined by a collective perimeter of the plurality of positions is non-uniform.

In an example embodiment, the non-uniform boundary is a perturbation of a substantially rounded boundary.

In an example embodiment, the non-uniform boundary may be a saw-toothed boundary.

In an example embodiment, the at least two metastructures that are indexed by the at least one phase delay are each characterized by a respective at least one variable parameter, the respective at least one variable parameter being different between the at least two metastructures.

In an example embodiment, the at least one variable parameter is a diameter of each of the at least two metastructures.

In an example embodiment, the metastructure library comprises a multi-dimensional metastructure library, wherein the multi-dimensional metastructure library comprises the at least two metastructures indexed by the at least one phase delay and the at least two metastructures have respective at least two variable parameters.

In an example embodiment, the at least two metastructures are substantially elliptical metastructures.

In an example embodiment, the at least two variable parameters are a vertex distance and a co-vertex distance of the at least two substantially elliptical metastructures.

In an example embodiment, the selecting further comprises randomly selecting the respective metastructure from the metastructure library to achieve the respective desired phase delay.

In an example embodiment, the selecting further comprises selecting, based on a fixed design rule algorithmically applied to disrupt periodic structures, the respective metastructure from the metastructure library.

In an example embodiment, the selecting further comprises selecting, using computer-assisted design, the respective metastructure from the metastructure library, and wherein a desired design is selected, and computer assistance is used to evaluate the design for periodicity.

In an example embodiment, the computer assistance is further used to vary geometric shape selections.

According to another aspect, an optical element is provided. In an example embodiment, the optical element includes a metasurface comprising an array of metastructures. Each metastructure of the array of metastructures is (a) associated with a respective phase delay and (b) characterized by a respective shape and a respective size. At least two metastructures are associated with a same phase delay and are characterized by at least one of different sizes or different shapes.

In an example embodiment, a boundary of the metastructure is defined by a collective perimeter of a plurality of positions of the metasurface, each metastructure of the array of metastructures located at a respective position of the plurality of positions, wherein the boundary is non-uniform.

In an example embodiment, a non-uniform boundary is a perturbation of a substantially rounded boundary.

In an example embodiment, a non-uniform boundary is a saw-toothed boundary.

According to another aspect, an optical element is provided. In an example embodiment, the optical element includes a metasurface comprising an array of metastructures. Each metastructure of the array of metastructures is associated with a respective phase delay and is located at a respective position of a plurality of positions.

In an example embodiment, a boundary of the metasurface is defined by a collective perimeter of the plurality of positions of the metasurface. In an example embodiment, the boundary is non-uniform.

In an example embodiment, a non-uniform boundary may be a perturbation of a substantially rounded boundary.

In an example embodiment, a non-uniform boundary may be a saw-toothed boundary.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a partial perspective view of an example metasurface with an array of metastructures on the surface thereof, according to an example embodiment.

FIG. 2A is a partial perspective view of an example circular cylindrical metastructure, according to an example embodiment.

FIG. 2B is a partial cross-sectional view of an example circular cylindrical metastructure, according to an example embodiment.

FIG. 3A is a partial perspective view of an example elliptical cylindrical metastructure, according to an example embodiment.

FIG. 3B is a partial cross-sectional view of an example elliptical cylindrical metastructure, according to an example embodiment.

FIG. 4A is a table showing an example circular pillar library.

FIG. 4B is a table showing an example elliptical pillar library.

FIG. 5 is a partial perspective view of an example metasurface with an array of metastructures on the surface thereof with a non-uniform boundary, according to an example embodiment.

FIG. 6 is an example interface for designing a metastructure, according to an example embodiment.

FIG. 7 is a flow chart showing an example method for assembling a metasurface with an array of metastructures on the surface thereof, according to an example embodiment.

FIG. 8 is a schematic diagram illustrating an example quantum computing system comprising an atomic object confinement apparatus comprising meta material structures on a surface thereof, according to an example embodiment.

FIG. 9 provides a schematic diagram of an example controller of a quantum computer configured to perform one or more deterministic reshaping and/or reordering functions, according to various embodiments.

FIG. 10 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

In various embodiments, metasurfaces configured to provide reduced diffractive orders, systems comprising such metasurfaces, and methods, apparatuses, computer program products, and/or the like for designing, generating, and/or fabricating such metasurfaces are provided. For example, various embodiments provide methods for designing and/or fabricating metasurfaces using a metastructure library that includes parameters defining a plurality of metastructures indexed by respective effective phase delays imparted to light that interacts with the corresponding metastructures. The term “effective phase delay” of a metastructure is the phase delay imparted to light that interacts with the metastructure modulo 2π (mod 2π). For at least one effective phase delay, the metastructure library comprises parameters that define at least two metastructures that differ in at least one of size or shape and that are indexed by the same effective phase delay. For example, various embodiments provide metasurfaces that include at least two metastructures that are intended to impart the same effective phase delay but that differ from one another in size and/or shape. For example, various embodiments provide metasurfaces having non-uniform boundaries.

Metasurfaces are optical components comprising a plurality or array of metastructures that can be designed to collectively affect a beam incident on the metasurface. In various embodiments, the array of metastructures can be designed to provide a focused beam at a desired output angle. In various embodiments, the array of metastructures can be designed to provide a beam and/or coherent illumination profiles at a desired output angle. Due to fabrication imperfections and challenges in simulating interaction of light with an entire metasurface, some incident light may exit a metasurface in diffracted orders, for example, emerging from periodicity of superstructures tied to phase wrapping. In various embodiments, randomizing or adding intentional apodization of emergent superstructures minimizes diffractive orders and/or improves beam quality. In various embodiments, amplitude apodization of metasurface aperture reduces Airy diffraction.

For example, periodicities in the array of metastructures and/or edge effects can cause a metasurface to generate diffractive orders and/or Airy diffraction. Diffractive effects cause light to be directed in various directions, which may lead to increased photon scattering and/or optical crosstalk between various channels of an optical system including the metasurface. For example, if the metasurface is configured to direct a coherent beam toward a particular position of an atomic object confinement apparatus (e.g., an ion trap) the diffractive effects may cause optical crosstalk between various positions of the atomic object confinement apparatus. Thus, technical problems exist regarding metasurfaces and design thereof.

Various embodiments provide technical solutions to these technical problems. In various embodiments, at least some of the periodicity of the array of metastructures is systemically removed, for example, to reduce the presence and/or production of diffractive orders. For example, in various embodiments, superstructures arising in the array of metastructures are apodized. In various embodiments, a multi-dimensional library of metastructures is generated that includes, for at least one effective phase delay, more than one element. In various embodiments, an extended library of metastructures is generated that includes, for at least one effective phase delay, multiple structures. In various embodiments, the multi-dimensional library of metastructures includes a plurality of metastructures that are each indexed and/or mapped to a particular effective phase delay. For example, the multi-dimensional library of metastructures includes at least two structures that provide the same effective phase delay. In various embodiments, the at least two structures may be of substantially the same shape but of different sizes. For example, the at least two structures may be circular cylinders with different diameters. In various embodiments, the at least two structures may be different shapes. For example, the at least two structures may be ellipses with different vertex and/or co-vertex distances (e.g., different major and/or minor radii). In various embodiments, the at least two structures have different optical responses in the metastructure array. In various embodiments, the library of metastructures is degenerate. For example, a degenerate library may comprise a set of discrete phase levels. At least one of the discrete phase levels may have degeneracy, meaning that there may be one or more elements (e.g., metastructures) having different shapes and/or sizes that occupy the at least one of the discrete phase levels. In various embodiments, selecting a metastructure to implement a discrete phase level comprises selecting from the set of degenerate shapes.

In various embodiments, a phase profile of the metasurface is determined which indicates a desired effective phase delay at one or more of a plurality of positions (e.g., a plurality of radii) of the metasurface. In various embodiments, for some metasurface designs, for example, such as off-axis lenses with high numerical apertures (NA), the periodicities remain but are much more difficult to see by eye (e.g., since multiple overlapping periodic super-structures are present). In various embodiments, the metasurface design is populated with metastructures from the extended and/or multi-dimensional libraries of metastructures in accordance with the desired effective phase delay at each position and/or radius of the metasurface. In various embodiments, for at least one position of the plurality of positions (e.g., for at least one radius), the metastructures used to populate that portion of the metasurface include more than one size or shape of metastructure. In various embodiments, for each position along the at least one radius, a metastructure of the corresponding effective phase delay is chosen (e.g., randomly chosen) from the library. In various embodiments, for each position along the at least one radius, a design rule may be used to govern the placement of the different metastructures corresponding to the effective phase delay. In various embodiments, for each position along the at least one radius, computer assisted design may be used to determine the placement of different metastructures corresponding to the effective phase delay. For example, a metasurface design may be evaluated for periodicity (e.g., using a Fourier transform and/or the like). In various embodiments, an identified periodicity may be addressed by modifying a corresponding portion of the design.

In various embodiments, each radius of the metasurface design includes two or more sizes and/or shapes of metastructures configured to provide substantially the same effective phase delay (e.g., the same phase delay mod 2π). In various embodiments, the radii which include two or more sizes and/or shapes of metastructures configured to provide the same effective phase delay are selected based on apodization priorities. In various embodiments, the apodization priorities may indicate that it is more important to apodize radii where larger diameter structures are adjacent to smaller diameter structures, particular periodic structures, particular phase ranges, particular sensitivities of the system, and/or the like. In various embodiments, a metasurface fabricated based on the desired design will include at least one radius having metastructures of different sizes. In various embodiments, a metasurface fabricated based on the desired design will include at least one radius having metastructures of different shapes. For example, the metasurface includes at least two metastructures that are intended to impart the same effective phase delay that differ from one another in size and/or shape.

Moreover, diffractive effects may arise from interaction of an incident beam with the edge or boundary of a metasurface. For example, these diffractive effects may be particularly present in instances where a metasurface or a group of metasurfaces are flood-illuminated by a laser beam. In various embodiments, to reduce such edge effects, the boundaries and/or edges of the metasurface are “blurred.” For example, the boundary of the metasurface may be a perturbation of a substantially rounded edge and/or straight-line edge (e.g., such as a saw-toothed edge and/or a serrated edge). In various embodiments, blurring the boundary of the metasurface may be aided by using metastructures near the boundary that produce a phase response similar to that of bare substrate. For example, blurring the boundary of the metasurface may diminish the edge effects caused by light interacting with the edge or boundary of the metasurface.

Thus, various embodiments provide technical improvements to the fields of metasurfaces and systems that include metasurfaces and/or other optical components that may be replaced with metasurfaces.

### Exemplary Metasurface Comprising Two or More Metastructures

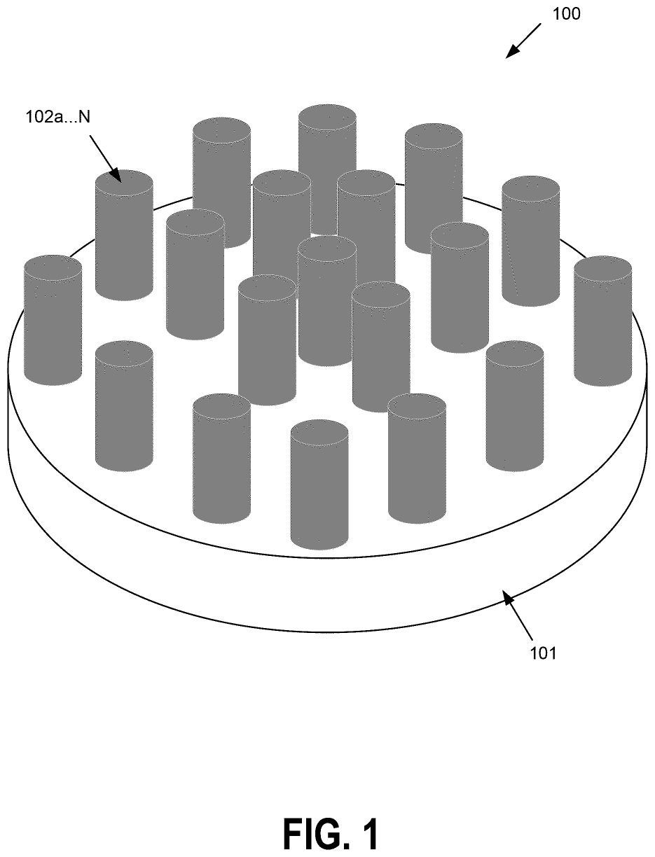

FIG. 1 is a partial perspective view of an example metasurface 100 with an array of metastructures on the surface thereof, according to an example embodiment. The metasurface 100 may be comprised of a substrate 101, metastructures 102a . . . N, and/or other components. In various embodiments, the substrate 101 may be a surface of an atomic object confinement apparatus. In various embodiments, the metastructures 102a . . . N are formed as an array of metastructures on the substrate 101. In various embodiments, the metastructures 102a . . . N are formed and/or disposed on the substrate 101 in respective positions. For example, in various embodiments, the metastructures 102a . . . N are formed and/or disposed on the substrate 101 in concentric circles. In another example, in various embodiments, the metastructures 102a . . . N are formed and/or disposed on the substrate 101 in positions defined by rows and columns. In various embodiments, the metastructures 102a . . . N are formed and/or disposed on the substrate 101 in other arrangements. In various embodiments, the metastructures 102a . . . N are comprised of circular metastructures, elliptical metastructures, other substantially rounded metastructures, and/or other types of metastructures.

In various embodiments, the metastructures 102a . . . N are comprised of metastructures selected and/or arranged to achieve a desired effective phase delay profile. For example, an incident beam may be incident on the metasurface 100. Interaction of the incident beam with the array of metastructures 102a . . . N causes an induced beam that is characterized by (approximately/nearly) the desired effective phase delay profile, with respect to the incident beam.

In various embodiments, the metastructures 102a . . . N are generally cylindrical structures having a defined height. In an example embodiment, the metastructures 102a . . . N are circular cylindrical metastructures. In an example embodiment, the metastructures 102a . . . N are elliptical cylindrical metastructures. The metastructures 102a . . . N may have various other cross-sectional shapes (e.g., square, rectangular, polygonal, and/or the like) in various embodiments, as appropriate for the application.

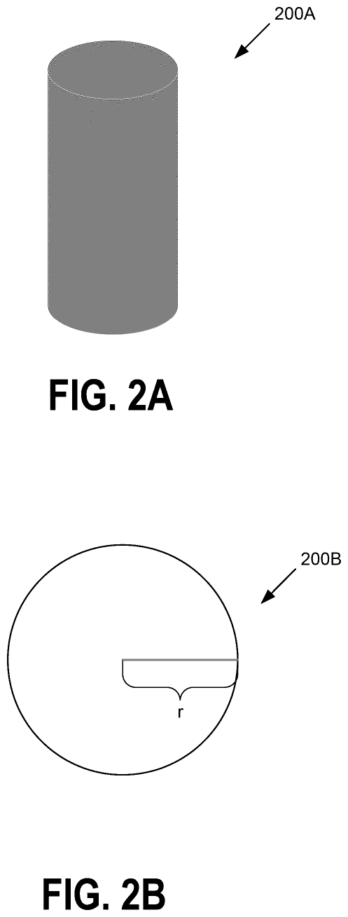

FIGS. 2A-2B show views of a circular cylindrical metastructure. FIG. 2A is a partial perspective view of an example circular cylindrical metastructure 200A, according to an example embodiment. The metastructure 200A may be a substantially circular cylinder, as shown in FIG. 2A. FIG. 2B is a partial cross-sectional view of an example circular cylindrical metastructure, according to an example embodiment. The cross-section of a circular cylindrical metastructure may be a circle 200B, as shown in FIG. 2B. The circle 200B may be defined by a radius r. The circle 200B may be a substantially circular shape.

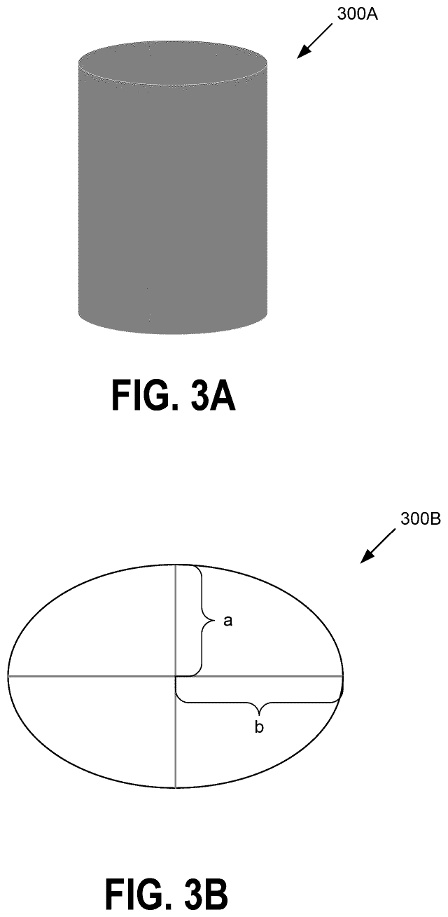

FIGS. 3A-3B show views of elliptical cylindrical metastructures. FIG. 3A is a partial perspective view of an example elliptical cylindrical metastructure, according to an example embodiment. The metastructure 300A may be a substantially elliptical cylinder, as shown in FIG. 3A. FIG. 3B is a partial cross-sectional view of an example elliptical cylindrical metastructure, according to an example embodiment. The cross-section of an elliptical cylindrical metastructure may be an ellipse 300B, as shown in FIG. 3B. The ellipse 300B may be defined by a minor axis (e.g., co-vertex distance) a and a major axis (e.g., vertex distance) b. The ellipse 300B may be a substantially elliptical shape.

In various embodiments, a respective effective phase delay is imparted to light, for example, if that light from an incident beam interacts with one of a plurality of metastructures (e.g., the metastructures 102a . . . N). In various embodiments, therefore, the portion of the light of the induced beam which interacted with a given metastructure becomes phase delayed compared to that same portion of light in the incident beam by a phase delay imparted by the given metastructure. In various embodiments, the phase delays on a plurality of the portions of light in the incident beam (e.g., all portions of light in the incident beam) are resultant of the incident beam interacting with a plurality of metastructures (e.g., all metastructures) in the beam profile of the induced beam.

In various embodiments, the metasurface includes two or more metastructures that are configured to impart the same effective phase delay which are different shapes and/or sizes. For example, in various embodiments, a circular cylindrical metastructure “a” and an elliptical cylindrical metastructure “b” may be configured to impart substantially the same effective phase delay as one another. For example, in various embodiments, a circular cylindrical metastructure with radius “r1” and a circular cylindrical metastructure with radius “r2” may be configured to impart substantially the same effective phase delay as one another.

In various embodiments, the metasurface may be designed using a metasurface library that includes two or more metastructures that are different shapes and/or sizes and have substantially the same effective phase delay.

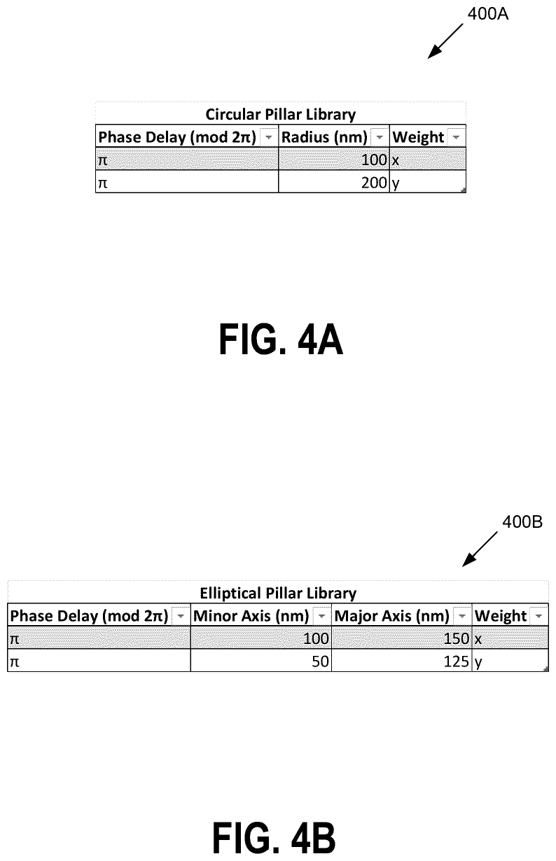

FIG. 4A is a table showing a portion of an example metasurface library that is a circular pillar library 400A. In various embodiments, the library 400A includes more than one metastructure for the same effective phase delay. For example, the library 400A may comprise a substantially circular cylindrical metastructure with radius r=100 nm for an effective phase delay π, with a weight x. For example, the library 400A may comprise a substantially circular cylindrical metastructure with radius r=200 nm for the same effective phase delay π, with a weight y. In various embodiments, the library 400A comprise many more substantially circular cylindrical metastructures with variable radii for the same and/or variable effective phase delays. In various embodiments, the library 400A is a multi-dimensional library. In various embodiments, the weights x and y indicate weights applied to various metastructures, for example, to indicate which may be more likely to be selected for a design rule. In various embodiments, the weights may be based on the effective phase delay and/or other optical properties achieved by the metastructure. In various embodiments, the weights indicate apodization priorities. In various embodiments, the apodization priorities may indicate that it is more important to apodize radii where larger diameter structures are adjacent to smaller diameter structures, particular periodic structures, particular phase ranges, particular sensitivities of the system, and/or the like.

FIG. 4B is a table showing a portion of an example metasurface library that is an elliptical pillar library 400B. In various embodiments, the library 400B includes more than one metastructure for the same effective phase delay. For example, the library 400B may comprise a substantially elliptical metastructure with a minor axis a=100 nm and a major axis b=150 nm for an effective phase delay if, with a weight x. For example, the library 400B may comprise a substantially elliptical metastructure with a minor axis a=50 nm and a major axis b=125 nm for an effective phase delay if, with a weight y. In various embodiments, the library 400B comprise many more substantially elliptical cylindrical metastructures with variable major and minor axes for the same and/or variable effective phase delays. In various embodiments, the library 400B is a multi-dimensional library. In various embodiments, the weights x and y indicate weights applied to various metastructures, for example, to indicate which may be more likely to be selected for a design rule. In various embodiments, the weights may be based on the effective phase delay achieved by the metastructure. In various embodiments, the weights indicate apodization priorities. In various embodiments, the apodization priorities may indicate that it is more important to apodize radii where larger diameter structures are adjacent to smaller diameter structures, particular periodic structures, particular phase ranges, particular sensitivities of the system, and/or the like.

In various embodiments, the metastructure libraries of FIGS. 4A-4B are multi-dimensional libraries. For example, a multi-dimensional library may include more than one element for at least one effective phase delay. In various embodiments, the metastructure libraries of FIGS. 4A-4B are extended libraries. For example, an extended library may include multiple structures for at least one effective phase delay. For example, the libraries 400A and 400B may be combined.

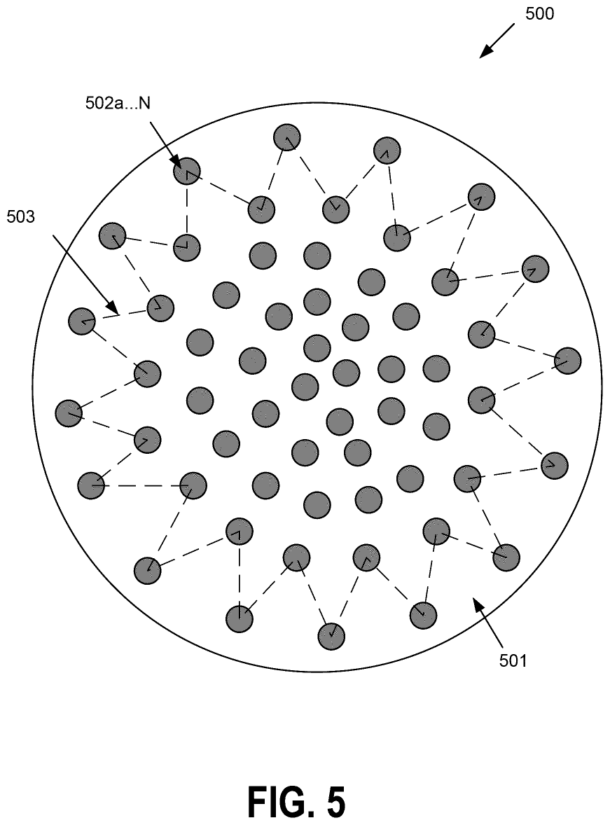

In various embodiments, the boundary of the metasurface, as defined by a polygon linking all of the outermost or edge positions of the metastructures, is non-uniform. FIG. 5 is a partial perspective view of an example metasurface 500 with an array of metastructures on the surface thereof with a non-uniform boundary, according to an example embodiment. Using a non-uniform boundary may have the effect of “blurring” the edges of the metasurface 500, aiding in the reduction of edge effects arising from the interaction of an incident beam with the boundary or edge of the metasurface 500.

The metasurface 500 may be comprised of a substrate 501, metastructures 502a . . . N, and/or other components. In various embodiments, the substrate 501 is a surface of an atomic object confinement apparatus. In various embodiments, the substrate 501 is coupled to a library of metastructures 502a . . . N. In various embodiments, a dashed line 503 represents the non-uniform boundary formed by the plurality of positions of the metastructures 502a . . . N. In various embodiments, the dashed line 503 represents a perturbation of a substantially rounded boundary. In various embodiments, the dashed line 503 represents a saw-toothed, serrated, and/or other type of boundary.

In various embodiments, the metastructures 502a . . . N are formed and/or disposed on the substrate 501 in concentric circles. In various embodiments, the metastructures 502a . . . N are formed and/or disposed on the substrate 501 in positions indicated by rows and columns. In various embodiments, the metastructures 502a . . . N are formed and/or disposed on the substrate 501 in positions indicated by concentric circles. In various embodiments, the metastructures 502a . . . N are formed and/or disposed on the substrate 101 in other arrangements. In various embodiments, the metastructures 502a . . . N are comprised of metastructures selected and/or arranged to achieve a desired effective phase delay. In various embodiments, the metastructures 502a . . . N are comprised of circular metastructures, elliptical metastructures, other substantially rounded metastructures, and/or other types of metastructures. In various embodiments, the metastructures at the boundary of the metasurface may be selected such that they achieve an effective phase delay substantially similar to that of bare substrate, for example, to reduce edge effects by “blurring” the boundary of the metasurface.

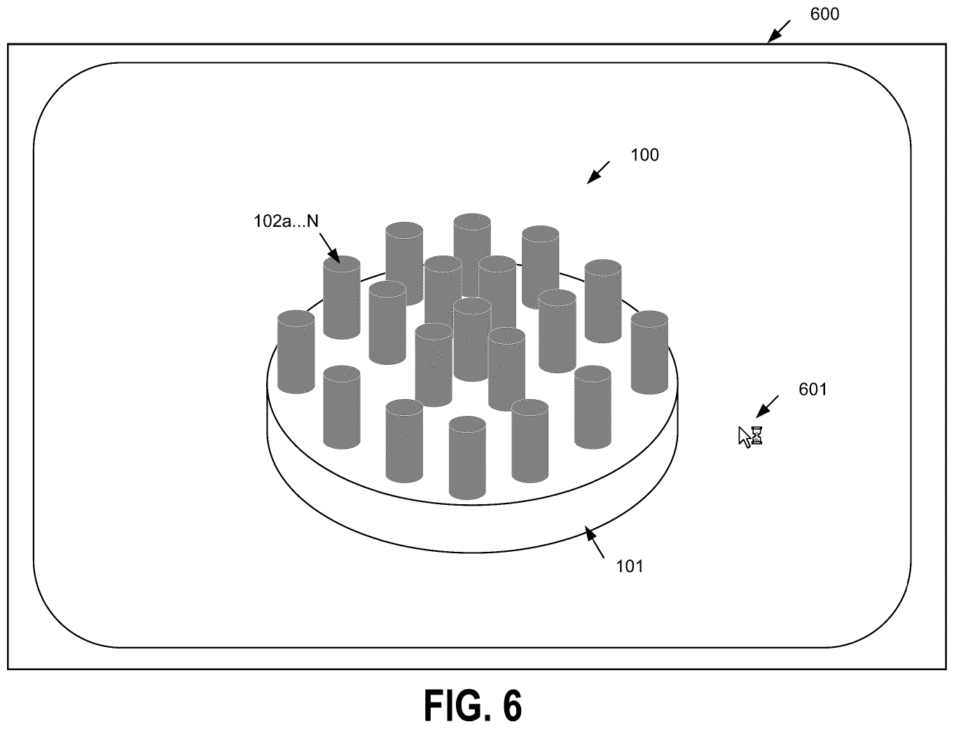

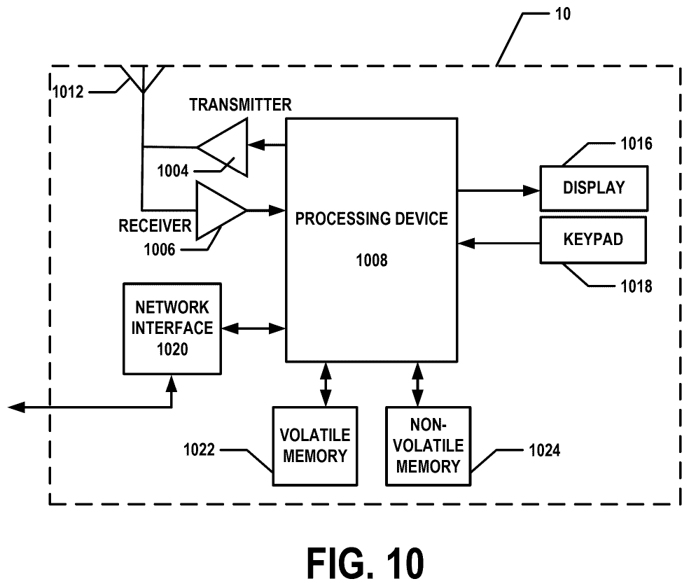

In various embodiments, the metastructure may be designed via computer-implemented methods. FIG. 6 is an example interface for designing a metastructure. FIG. 6 shows an interface 600 and a cursor 601. The interface 600 may be computer interface such as a graphic user interface (GUI) displayed via a display 1016 of a computing entity 10 (see FIG. 10). The cursor 601 may allow a user to interact with various components of the user interface such as selecting metastructures for positioning in respective positions of the metasurface, for example. As described herein, a computer-implemented method for designing a metasurface may comprise selecting and/or defining a boundary, determining a desired phase profile, and/or selecting a respective metastructure from a metastructure library. For example, in various embodiments, such a computer-implemented method may be implemented by an interface such as the interface 600.

### Exemplary Method for Designing a Metasurface Comprising Two or More Metastructures

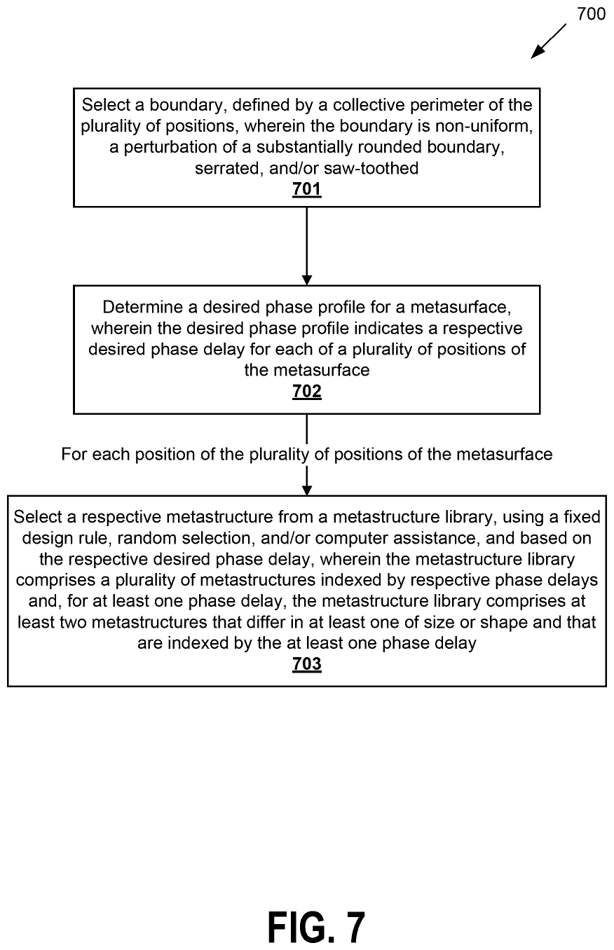

FIG. 7 is a flow chart showing an example method 700 for designing a metasurface with an array of metastructures on the surface thereof, according to an example embodiment. At step 701, a computing entity 10 selects a boundary for the metastructure. In an example embodiment, the computing entity 10 selects a boundary based on user input indicating a selected boundary. In various embodiments, the computing entity 10 selects a boundary from a plurality of boundaries and/or defines a boundary using a boundary defining algorithm based on one or more properties of the metasurface. For example, a user and/or input data object or file may include one or more properties of the metasurface such as a size of the metasurface (e.g., dimensions, surface area, etc.), intended use of the metasurface, fabrication considerations, a layout defining the plurality of positions of the metasurface, and/or the like. In various embodiments, the computing entity 10 selects the boundary by accessing a boundary and/or information defining the boundary from memory (e.g., volatile memory 1022 and/or non-volatile memory 1024, see FIG. 10).

In various embodiments, the boundary is defined by a collective perimeter of the plurality of positions of the metasurface. In various embodiments, the boundary is non-uniform (see FIG. 5). For example, the boundary may be a perturbation of substantially rounded boundary (e.g., a circle and/or substantially circular shape). For example, the boundary may be a serrated boundary. For example, the boundary may be a saw-toothed boundary.

At step 702, the computing entity 10 determines a desired phase profile for the metasurface. In various embodiments, a plurality of positions of the metasurface are defined and the desired phase profile indicates a respective desired effective phase delay for each of the plurality of positions of the metasurface. In various embodiments, the plurality of positions of the metasurface correspond to the various positions such as described with respect to FIGS. 1 and 6.

In various embodiments, the computing entity 10 determines the desired phase profile based on a desired function of the metasurface. For example, a user may provide user input (e.g., via interface 600 and/or the like) indicating that the metasurface is desired to provide a coherent beam focused at a particular location (e.g., a particular angle with respect to a defined reference direction and/or a defined distance from the metasurface) in response to an incident beam being incident on the metasurface. The computing entity 10 may then determine an effective phase delay for each position of the plurality of positions to provide a coherent beam focused at the particular location. In another example, the computing entity determines the desired phase profile by accessing a data object or file from memory (e.g., volatile memory 1022 and/or non-volatile memory 1024) that defines the plurality of positions and the desired effective phase delay for each position of the plurality of positions. In another example, a user provides a desired effective phase delay for each position of the plurality of positions via the interface 600.

At step 703, for each position of the plurality of positions of the metasurface, the computing entity 10 selects a respective structure from a metastructure library (e.g., such as the libraries of FIGS. 4A and 4B), for example, to achieve a respective desired effective phase delay of the respective position. In various embodiments, the computing entity 10 selects the respective structure for a respective position based on one or more of user input (e.g., received via a user input device such as keypad 1018, see FIG. 10, and/or the like), a random selection (possibly a weighted random selection) of the respective structure based at least in part on the respective structure being indexed within the metastructure library by an effective phase delay that substantially matches the desired effective phase delay assigned to the respective position, an algorithmic selection of the respective structure based at least in part on the respective structure being indexed within the metastructure library by an effective phase delay that substantially matches the desired effective phase delay assigned to the respective position, and/or the like.

In various embodiments, the metastructure library comprises a multi-dimensional metastructure library, wherein the multi-dimensional metastructure library comprises at least two metastructures indexed by at least one same effective phase delay and the at least two metastructures have, respectively, at least two variable parameters (e.g., the major and minor axes of an elliptical cylindrical metastructure). In various embodiments, the metastructure library is an extended metastructure library, wherein the extended metastructure library comprises at least two metastructures indexed by at least one same effective phase delay and the at least two metastructures have, respectively, one variable parameter (e.g., the radius of a circular cylindrical metastructure).

In various embodiments, the respective metastructure is selected from the metastructure library using a fixed design rule. For example, the computing entity 10 may algorithmically select the respective metastructure using a fixed design rule. In various embodiments, the fixed design rule is algorithmically applied to disrupt periodic structures. In various embodiments, the respective structure is selected from the metastructure library using random selection. In various embodiments, the respective structure is selected from the metastructure library using computer assistance. In various embodiments, a desired design is selected and/or generated, and computer-assisted design is used to evaluate the design for periodicity (e.g., using Fourier transforms, etc.). In various embodiments, the computer assistance is used to vary geometric shape selections. In various embodiments, the respective structure is selected from the metastructure library based on the respective desired effective phase delay.

In various embodiments, the metastructure library comprises a plurality of metastructures indexed by respective effective phase delays and, for at least one effective phase delay, the metastructure library comprises at least two metastructures that are indexed by the same at least one effective phase delay, that differ in size and/or shape. The at least two metastructures may comprise one or more variable parameters, for example, such as shown in FIGS. 2A-3B. In various embodiments, the one or more variable parameters may be diameter, vertex distance, co-vertex distance, and/or other parameters.

In various embodiments, the metasurface may then be fabricated based on the metasurface design determined through method 700. For example, various fabrication techniques may be used, as appropriate for the application to fabricate the metasurface 100, 600 based on a metasurface design determined through method 700. In various embodiments, the method 700 may be a computer-implemented method. For example, the metasurface 100, 600 may be fabricated such that at least two metastructures of plurality of metastructures 102a . . . N, 602a . . . N are configured to impart the same effective phase delay to light that interacts therewith, but that have different shapes (e.g., different major and/or minor axis) and/or different sizes (e.g., different radii).

For example, the computing entity 10 may provide an output indicating the metasurface design (e.g., the respective parameters of each respective metastructure and the respective position to which the respective metastructure is assigned). In various embodiments, the metasurface design is provided as a computer-assisted design or computer-aided design (CAD) file. In various embodiments, the metasurface design is provided as a table or in text format. In various embodiments, the metasurface design is provided in a graphical format. For example, the output indicating the metasurface design may be provided via display 1016, transmitted via transmitter 1004 or network interface 1020, and/or the like (see FIG. 10). In various embodiments, the metasurface is fabricated based at least in part on the output indicating the metasurface design.

### Technical Advantages

Various embodiments provide technical advantages, as described herein. In various embodiments, at least some of the periodicity of the array of metastructures is systemically removed, for example, to reduce the presence of diffractive orders. In various embodiments, using a multi-dimensional and/or extended library of metastructures with variable parameters (e.g., size and/or shape) aids in removing some of the periodicity arising from the array of metastructures. In various embodiments, superstructures arising in the array of metastructures are apodized. The apodization may be achieved by using a non-uniform boundary for a plurality of positions of metastructures (e.g., such as shown by the dashed line 503 in FIG. 5). In various embodiments, randomizing or adding intentional apodization of emergent superstructures minimizes diffractive orders and/or improves beam quality. In various embodiments, amplitude apodization of metasurface aperture reduces Airy diffraction.

### Exemplary Quantum Computing System Comprising an Atomic Object Confinement Apparatus

Various embodiments provide metasurfaces comprising an array of metastructures where at least two metastructures of the array of metastructures are configured to impart a same effective phase delay but the at least two metastructures differ from one another in shape and/or size. Various embodiments provide systems that include one or more of such metasurfaces. Various embodiments provide various optical, electro-optical, opto-mechanical systems that include such metasurfaces. One example system is a quantum computing system.

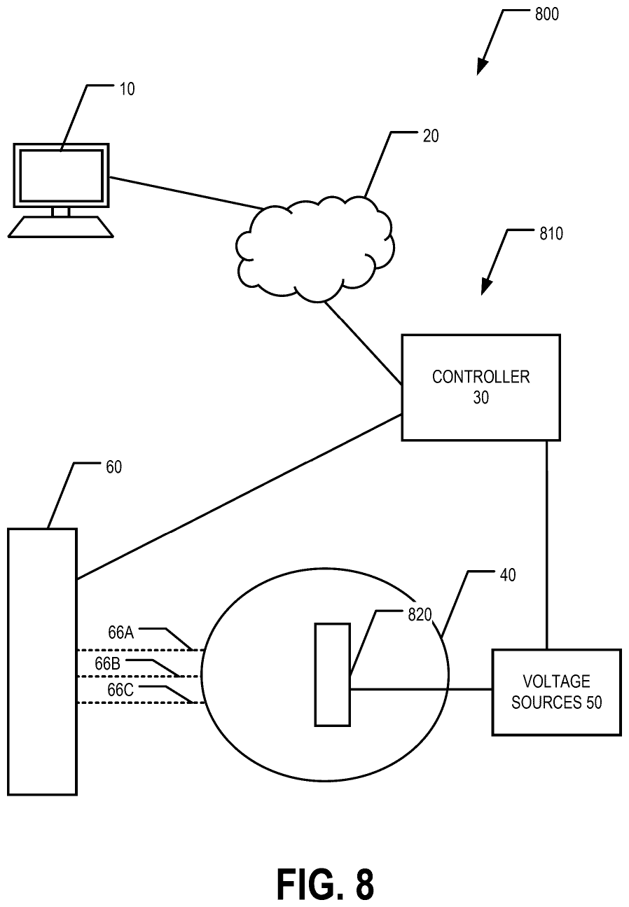

FIG. 8 provides a schematic diagram of an example quantum computing system 800 comprising an atomic object confinement apparatus 820 (e.g., an ion trap and/or the like), in accordance with an example embodiment. As shown in FIGS. 1 and 6, a plurality of meta material structures is formed and/or disposed on a substrate 101. In various embodiments, the substrate 101 is a surface of the atomic object confinement apparatus and/or another substrate that is secured with respect to the atomic object confinement apparatus. In various embodiments, at least a portion of the meta material structures formed and/or disposed on the surface of the atomic object confinement apparatus or other substrate are configured to be induced to emit an action signal toward and/or focused onto a respective atomic object location responsive to an incoming signal being incident thereon. For example, the incoming signal may be at least a portion of a manipulation signal generated by a manipulation source 60 of the quantum computer 810. In various embodiments, at least a portion of the meta material structures formed and/or disposed on the surface of the atomic object confinement apparatus are configured to be induced to emit a collection signal toward and/or focused onto a collection position (e.g., where corresponding collection optical elements are disposed) corresponding to the respective atomic object position responsive to an emitted signal emitted by an atomic object located at the respective atomic object position.

For example, in various embodiments, an atomic object confinement apparatus having one or more arrays of metastructures formed and/or disposed on the surface of the atomic object confinement apparatus or a confinement apparatus assembly comprising an atomic object confinement apparatus and another substrate secured with respect to the atomic object confinement apparatus and having one or more arrays of metastructures formed and/or disposed on a surface thereof is provided. In various embodiments, each array of metastructures is formed and/or configured for use in performing one or more functions (photoionization, state preparation, qubit detection and/or reading, cooling, shelving, repumping, single qubit gates, two qubit gates, and/or the like) of a confined atomic object quantum computer (e.g., a QCCD-based quantum computer).

For example, each array of metastructures may comprise metastructures configured to be induced to emit an action signal and/or collection signal responsive to an incoming signal and/or emitted signal within a corresponding wavelength range being incident thereon. For example, each function of the quantum computer may be associated with one or more wavelengths. An array of metastructures may therefore correspond to one or more functions of the quantum computer that correspond to a wavelength within the wavelength range that the metastructures of the array are configured to operate at.

In various embodiments, the quantum computing system 800 comprises a computing entity 10 and a quantum computer 810. In various embodiments, the quantum computer 810 comprises a controller 30, a cryostat and/or vacuum chamber 40 enclosing a confinement apparatus 820 (e.g., an ion trap), and one or more manipulation sources 60. For example, the cryostat and/or vacuum chamber 40 may be a pressure-controlled chamber. In an example embodiment, the manipulation signals generated by the manipulation sources 60 are provided to the interior of the cryostat and/or vacuum chamber 40 (where the atomic object confinement apparatus 820 is located) via corresponding optical paths 66 (e.g., 66A, 66B, 66C). In an example embodiment, the one or more manipulation sources 60 may comprise one or more lasers (e.g., optical lasers, microwave sources, and/or the like). In various embodiments, each manipulation source is configured to generate a manipulation signal having a respective characteristic wavelength in the microwave, infrared, visible, or ultraviolet portion of the electromagnetic spectrum. In various embodiments, the one or more manipulation sources 60 are configured to manipulate and/or cause a controlled quantum state evolution of one or more atomic objects within the confinement apparatus. For example, in an example embodiment, wherein the one or more manipulation sources 60 comprise one or more lasers, the lasers may provide one or more laser beams to atomic objects trapped within the confinement apparatus 820 within the cryostat and/or vacuum chamber 40. For example, a manipulation source 60 generates a manipulation signal that is provided as an incoming signal to an appropriate array of meta material structures formed and/or disposed on the surface of the atomic object confinement apparatus 820. The incoming signal being incident on the array of meta material structures induces the meta material structures to emit an action signal directed toward and/or focused at a corresponding atomic object position of the atomic object confinement apparatus. For example, the manipulation sources 60 may be configured to generate one or more beams that may be used to initialize an atomic object into a state of a qubit space such that the atomic object may be used as a qubit of the confined atomic object quantum computer, perform one or more gates on one or more qubits of the confined atomic object quantum computer, read and/or determine a state of one or more qubits of the confined atomic object quantum computer, and/or the like.

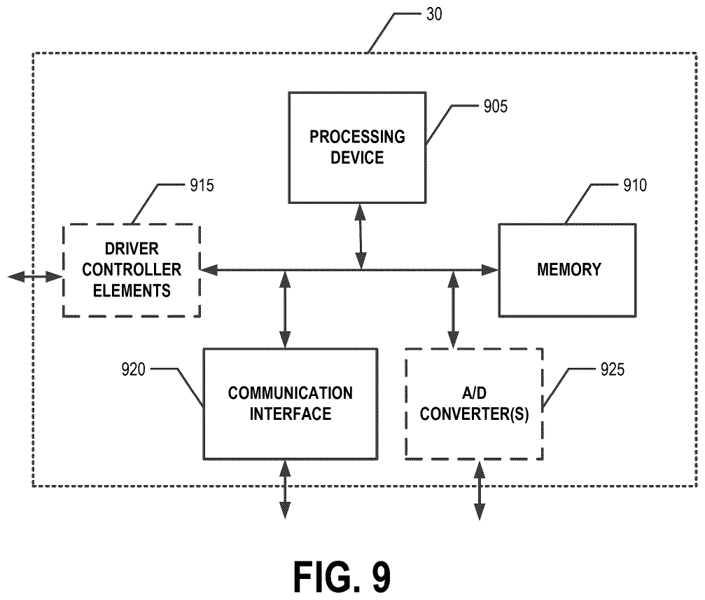

In various embodiments, the quantum computer 810 comprises an optics collection system configured to collect and/or detect photons generated by qubits (e.g., during reading procedures). The optics collection system may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum computer. In various embodiments, the detectors may be in electronic communication with the controller 30 via one or more A/D converters 925 (see FIG. 9) and/or the like. For example, an atomic object being read and/or having its quantum state determined may emit an emitted signal, at least a portion of which is incident on a collection array of meta material structures formed and/or disposed on the surface of the atomic object confinement apparatus 820. The emitted signal being incident on the collection array of meta material structures induces the meta material structures to emit a detected signal directed toward and/or focused at collection optics of the atomic object confinement apparatus. The collection optics are configured to provide the collection signal to a photodetector.

In various embodiments, the quantum computer 810 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 820, in an example embodiment.

In various embodiments, a computing entity 10 is configured to allow a user to provide input to the quantum computer 810 (e.g., via a user interface of the computing entity 10) and receive, view, and/or the like output from the quantum computer 810. The computing entity 10 may be in communication with the controller 30 of the quantum computer 810 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, and/or the like) within the cryostat and/or vacuum chamber 40 and/or configured to manipulate and/or cause a controlled evolution of quantum states of one or more atomic objects within the confinement apparatus. For example, the controller 30 may cause a controlled evolution of quantum states of one or more atomic objects within the confinement apparatus to execute a quantum circuit and/or algorithm. For example, the controller 30 may cause a reading procedure comprising coherent shelving to be performed, possibly as part of executing a quantum circuit and/or algorithm. In various embodiments, the atomic objects confined within the confinement apparatus are used as qubits of the quantum computer 810.

### Exemplary Controller

In various embodiments, a confinement apparatus 820 is incorporated into a system (e.g., a quantum computer 810) comprising a controller 30. In various embodiments, the controller 30 is configured to control various elements of the system (e.g., quantum computer 810). For example, the controller 30 may be configured to control the voltage sources 50, a cryostat system and/or vacuum system controlling the temperature and pressure within the cryostat and/or vacuum chamber 40, manipulation sources 60, cooling system, and/or other systems controlling the environmental conditions (e.g., temperature, humidity, pressure, and/or the like) within the cryostat and/or vacuum chamber 40 and/or configured to manipulate and/or cause a controlled evolution of quantum states of one or more atomic objects confined by the atomic object confinement apparatus 820. In various embodiments, the controller 30 may be configured to receive signals from one or more optics collection systems.

As shown in FIG. 9, in various embodiments, the controller 30 may comprise various controller elements including processing elements 905, memory 910, driver controller elements 915, a communication interface 920, analog-digital converter elements 925, and/or the like. For example, the processing elements 905 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 905 of the controller 30 comprises a clock and/or is in communication with a clock.

For example, the memory 910 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 910 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 910 (e.g., by a processing element 905) causes the controller 30 to perform one or more steps, operations, processes, procedures and/or the like described herein for providing manipulation signals to atomic object locations and/or collecting, detecting, capturing, and/or measuring indications of emitted signals emitted by atomic objects located at corresponding atomic object locations of the atomic object confinement apparatus 820.

In various embodiments, the driver controller elements 915 may include one or more drivers and/or controller elements each configured to control one or more drivers. In various embodiments, the driver controller elements 915 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 905). In various embodiments, the driver controller elements 915 may enable the controller 30 to operate a voltage sources 50, manipulation sources 60, cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping potential of the atomic object confinement apparatus 820 (and/or other drivers for providing driver action sequences to potential generating elements of the atomic object confinement apparatus); cryostat and/or vacuum system component drivers; cooling system drivers, and/or the like. In various embodiments, the controller 30 comprises means for communicating and/or receiving signals from one or more optical receiver components (e.g., photodetectors of the optics collection system). For example, the controller 30 may comprise one or more analog-digital converter elements 925 configured to receive signals from one or more optical receiver components (e.g., a photodetector of the optics collection system), calibration sensors, and/or the like.

In various embodiments, the controller 30 may comprise a communication interface 920 for interfacing and/or communicating with a computing entity 10. For example, the controller 30 may comprise a communication interface 920 for receiving executable instructions, command sets, and/or the like from the computing entity 10 and providing output received from the quantum computer 810 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Exemplary Computing Entity

FIG. 10 provides an illustrative schematic representative of an example computing entity 10 that can be used in conjunction with embodiments of the present invention. In various embodiments, the computing entity 10 is a classical or semiconductor-based computing apparatus that is part of the quantum computing system 800. In various embodiments, the computing entity 10 is a classical or semiconductor-based computing apparatus that is used to generate a metasurface design of a metasurface.

In various embodiments where the computing entity 10 is part of the quantum computing system 800, the computing entity 10 is configured to allow a user to provide input to the quantum computer 810 (e.g., via a user interface of the computing entity 10) and receive, display, analyze, and/or the like output from the quantum computer 810.

As shown in FIG. 10, a computing entity 10 can include an antenna 1012, a transmitter 1004 (e.g., radio), a receiver 1006 (e.g., radio), and a processing element 1008 that provides signals to and receives signals from the transmitter 1004 and receiver 1006, respectively. The signals provided to and received from the transmitter 1004 and the receiver 1006, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 comprises one or more network interfaces 1020 configured for communicating via one or more wired and/or wireless computer networks.

The computing entity 10 may also comprise a user interface device comprising one or more user input/output interfaces (e.g., a display 1016 and/or speaker/speaker driver coupled to a processing element 1008 and a touch screen, keyboard, mouse, and/or microphone coupled to a processing element 1008). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1018 (hard or soft), a touch display, voice/speech or motion interfaces, scanners, readers, or other input device. In embodiments including a keypad 1018, the keypad 1018 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1022 and/or non-volatile storage or memory 1024, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
determining a desired phase profile of a metasurface, wherein the desired phase profile indicates a respective desired effective phase delay for each of a plurality of positions of the metasurface; and
for each position of the plurality of positions of the metasurface, selecting a respective metastructure from a metastructure library based on the respective desired effective phase delay, wherein the metastructure library comprises a plurality of metastructures indexed by respective effective phase delays and, for at least one effective phase delay, the metastructure library comprises at least two metastructures that differ in at least one of size or shape and that are indexed by the at least one effective phase delay.

2. The method of claim 1, wherein a boundary of the metasurface defined by a collective perimeter of the plurality of positions is non-uniform.

3. The method of claim 2, wherein the non-uniform boundary is a perturbation of a substantially rounded boundary.

4. The method of claim 2, wherein the non-uniform boundary is a saw-toothed boundary.

5. The method of claim 1, wherein the at least two metastructures that are indexed by the at least one effective phase delay which are each characterized by a respective at least one variable parameter, the respective at least one variable parameter being different between the at least two metastructures.

6. The method of claim 5, wherein the at least one variable parameter is a diameter of each of the at least two metastructures.

7. The method of claim 1, wherein the metastructure library comprises a multi-dimensional metastructure library, wherein the multi-dimensional metastructure library comprises the at least two metastructures indexed by the at least one effective phase delay and the at least two metastructures have respective at least two variable parameters.

8. The method of claim 7, wherein the at least two metastructures are substantially elliptical metastructures.

9. The method of claim 7, wherein the at least two variable parameters are a vertex distance and a co-vertex distance of the at least two substantially elliptical metastructures.

10. The method of claim 1, wherein the selecting further comprises randomly selecting the respective metastructure from the metastructure library to achieve the respective desired effective phase delay.

11. The method of claim 1, wherein the selecting further comprises selecting, based on a fixed design rule algorithmically applied to disrupt periodic structures, the respective metastructure from the metastructure library.

12. The method of claim 1, wherein the selecting further comprises selecting, using computer-assisted design, the respective metastructure from the metastructure library, and wherein a desired design is selected, and computer assistance is used to evaluate the design for periodicity.

13. The method of claim 12, wherein the computer assistance is further used to vary geometric shape selections.

14. An optical element comprising:
a metasurface comprising an array of metastructures, wherein each metastructure of the array of metastructures is (a) associated with a respective effective phase delay and (b) characterized by a respective shape and a respective size and wherein at least two metastructures are associated with a same effective phase delay and are characterized by at least one of different sizes or different shapes.

15. The optical element of claim 14, wherein a boundary of the metastructure is defined by a collective perimeter of a plurality of positions of the metasurface, each metastructure of the array of metastructures located at a respective position of the plurality of positions, wherein the boundary is non-uniform.

16. The optical element of claim 14, wherein the non-uniform boundary is a perturbation of a substantially rounded boundary.

17. The optical element of claim 14, wherein the non-uniform boundary is a saw-toothed boundary.

18. An optical element comprising:
a metasurface comprising an array of metastructures, wherein each metastructure of the array of metastructures is associated with a respective effective phase delay and is located at a respective position of a plurality of positions, wherein a boundary of the metasurface is defined by a collective perimeter of the plurality of positions of the metasurface, and the boundary is non-uniform.

19. The optical element of claim 18, wherein the non-uniform boundary is a perturbation of a substantially rounded boundary.

20. The optical element of claim 18, wherein the non-uniform boundary is a saw-toothed boundary.
